(19) United States
(12) Patent Application Publication
(10) Pub. No.: US 2022/0299639 A1
(43) Pub. Date: Sep. 22, 2022

(54) OPTICAL SENSOR AND METHOD FOR MANUFACTURING OPTICAL SENSOR

(71) Applicant: SHUNSIN TECHNOLOGY (ZHONG SHAN) LIMITED, Zhongshan (CN)

(72) Inventor: SHUN-HSING LIAO, Zhongshan City (CN)

(21) Appl. No.: 17/212,011

(22) Filed: Mar. 25, 2021

(30) Foreign Application Priority Data
Mar. 19, 2021 (CN) 202110295191.9

(51) Int. Cl. G01S 17/08; G01S 17/894; G01S 7/4865; G01S 7/481; H04B 10/07

(52) U.S. Cl. CPC G01S 17/08; G01S 17/894; G01S 7/4865; G01S 7/481; H04B 10/07

(57) ABSTRACT

An optical sensor employed in time-of-flight distance detection which avoids undesired light affecting the integrity of distance measurement includes a substrate, a cover, a light emitter, a photodetector, and an optical blocking element. The cover is connected with the substrate and forms an internal space. The cover has a protrusion, a first light transmitting portion, and a second light transmitting portion. The protrusion extends toward the substrate and has a bottom, and divides the internal space into an interconnected first chamber and second chamber. The light emitter is arranged on the substrate and located in the first chamber. The photodetector is disposed on the substrate and located in the second chamber. The first optical blocking element is disposed on the photodetector and extends toward the cover and beyond the bottom of the protrusion.

### FIELD

The subject matter herein generally relates to optical transmissions and sensors.

### BACKGROUND

A time-of-flight (ToF) measurement can measure the distance between a sensor and an object, based on the time difference between the emission of a light and its return to the sensor, after being reflected by an object.

However, optical sensors that use time-of-flight distance measurement suffer from internal light leakage, which affects the accuracy of distance measurement. Therefore, there is room for improvement within the art.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a schematic cross-sectional diagram of an optical sensor according to an embodiment of the disclosure; and

FIGS. 2A, 2B, 2C, 2D, 2E, and 2F are schematic cross-sectional diagrams illustrating a process flow according to a method of manufacturing an optical sensor according to an embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether direct1y or indirect1y through intervening components, and is not necessarily limited to physical connections. The connection can be such that the objects are permanent1y connected or releasably connected. The term “comprising,” when utilized, means “including, but not necessarily limited to”; it specifically indicates open-ended inclusion or membership in the so-described combination, group, series, and the like.

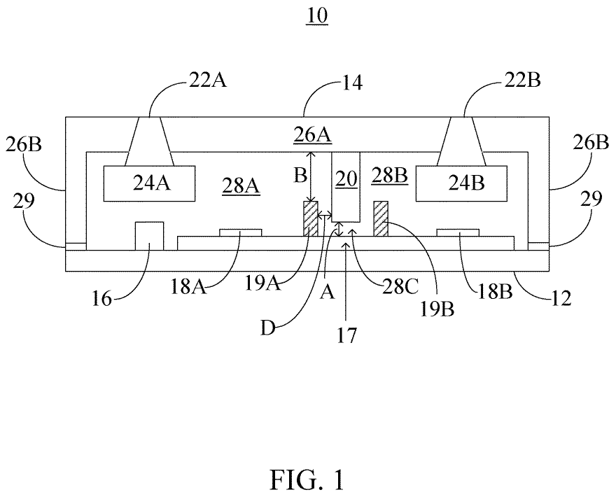

FIG. 1 illustrates an optical sensor according to an embodiment of the disclosure. As shown in FIG. 1, the optical sensor 10 comprises a substrate 12, a cover 14, a light emitter 16, a photodetector 17, a first optical blocking element 19A and a second optical blocking element 19B.

The substrate 12 can be made of different materials, such as plastic materials, epoxy materials, composite materials, FR-4 materials, or ceramic materials. The substrate 12 has an interconnection structure which has bonding pads to couple with related electronic components. The related electronic components may include circuit components and control circuits necessary for implementing the function of transmitting or receiving light signals. The related electronic components are well known to those skilled in the art, and will not be repeated here.

The cover 14 is connected to the substrate 12 and forms an internal space with the substrate 12. According to an embodiment, the material of the cover 14 may be an opaque plastic polymer material. The cover 14 comprises a top cover 26A and side walls 26B extending from the periphery of the top cover 26A toward the substrate 12 and connected to the substrate 12. The cover 14 further comprises a protrusion 20, a first light transmitting portion 22A, and a second light transmitting portion 22B. The protrusion 20 is located on the surface of the top cover 26A facing the substrate 12 and extends toward the substrate 12. According to the embodiment, the protrusion 20 may be an independent element or can be integrally formed with the top cover 26A. Through the protrusion 20, the internal space formed by the cover 14 and the substrate 12 is divided into a first chamber 28A and a second chamber 28B that communicate with each other. As shown in FIG. 1, there is a communication chamber 28C between the first chamber 28A and the second chamber 28B, that is, between the bottom of the protrusion 20 and the substrate 12.

The light emitter 16 is disposed on the substrate 12 and located in the first chamber 28A. In the embodiment of the disclosure, the light emitter 16 can be one or multiple vertical cavity surface emitting laser diodes (hereinafter referred to as VCSELs). The VCSELs form an array to emit light signals. In other embodiments, the light emitter 16 can be light emitting diodes, edge emitting laser diodes (EELD), or distributed feedback lasers (DFB). In an embodiment of the disclosure, the light emitter 16 emits light beams in the infrared waveband. In other embodiments, the light emitter 16 can also emit light in other wavebands such as visible light and ultraviolet light.

According to an embodiment of the disclosure, the photodetector 17 may include spatially distributed photosensitive elements, such as a reference photodetection component 18A and a measurement photodetection component 18B. Both the reference photodetection component 18A and the measurement photodetection component 18B can sense the light beam emitted by the transmitter 106, but the measured time points are different. The reference photodetection component 18A is located in the first chamber 28A. The measurement photodetection component 18B is located in the second chamber 28B. The types of measurement photodetection component 18B and reference photodetection component 18A may include PN-type photodiodes, PIN-type photodiodes, avalanche-type photodiodes, charge coupled devices (CCD) and complementary metal-oxide semiconductors (CMOS). In this embodiment, the reference photodetection component 18A and the measurement photodetection component 18B are both located on the photodetector 17. In other embodiments, the reference photodetection component 18A and the measurement photodetection component 18B may be located on different chips.

In addition, the first light filter 24A and the second light filter 24B are respectively provided in the first light transmitting portion 22A and the second light transmitting portion 22B. The position of the first light transmitting part 22A corresponds to the light emitter 16, and that of the second light transmitting part 22B corresponds to the measurement photodetection component 18B. The light emitter 16 emits a light beam according to the control signal issued by the control circuit (not shown in the figures). The emitted light beam passes through the first light filter 24A of the first light transmitting portion 22A to be reflected by a target, and returns to the measurement photodetection component 18B through the second light filter 24B of the second light transmitting portion 22B.

The first optical filter 24A and the second optical filter 24B are designed to filter out light outside the frequency band emitted by the optical transmitter 16, so that the measurement photodetection component 18B can analyze the pure received light more accurately. According to another embodiment, a lens may be used instead of the optical filter to control the direction of the emitted light beam, or a lens combined with the optical filter may be used to achieve better optical path and light transmission quality.

The first optical blocking element 19A is disposed on the photodetector 17 and extends from the photodetector 17 toward the top cover 26A of the cover 14 and beyond the bottom of the protrusion 20. As shown in FIG. 1, there is a first distance A between the bottom of the protrusion 20 and the photodetector 17, a second distance B between the top of the first optical blocking element 19A and the top cover 26A, and a third distance D between the first optical blocking element 19A and the protrusion 20 along the direction parallel to the surface of the substrate 12. The first distance A, the second distance B, and the third distance D are non-zero physical distances. In addition, a second optical blocking element 19B can also be provided between the measurement photodetection component 18B and the protrusion 20. The material and function of the second optical blocking element 19B are similar to those of the first optical blocking element 19A, so the description will not be repeated to simplify the content. Noted that both the first optical blocking element 19A and the second optical blocking element 19B can be used alternatively or simultaneously according to actual needs or size requirements.

According to an embodiment of the disclosure, the material of the first optical blocking element 19A and the second optical blocking element 19B can be a material with light-absorbing properties, such as dark-colored polymer materials such as black paint or green paint, to reduce the risk of stray light entering the second chamber 28B from the first chamber 28A through the communication chamber 28C.

In addition, according to an embodiment of the disclosure, the substrate 12 and the cover 14 of the optical sensor 10 can be joined adhesively, by adhesive layer 29. Similarly, the light emitter 16 and the photodetector 17 can be fixed on the substrate 12 adhesively, and the first optical blocking element 19A and the second optical blocking element 19B can also be fixed on the photodetector 17 adhesively. In other embodiments, the material of the first optical blocking element 19A and the second optical blocking element 19B can also be the same material as the adhesive layer, as long as the height of the cured adhesive layer can be maintained beyond the bottom of the protrusion 20.

According to an embodiment of the disclosure, the adhesive layer 29 can be formed of various materials, including a polyimide (PI), polyethylene terephthalate (PET), Teflon, liquid crystal polymer (LCP), polyethylene (PE), polypropylene (PP), polystyrene (PS), polyvinyl Chloride (PVC), nylon or polyamides, polymethyl polymethylmethacrylate (PMMA), acrylonitrile-butadiene-styrene, phenolic pesins, epoxy resin, polyester, silicone, polyurethane (PU), polyamide-imide (PAI) or a combination thereof, not being limited thereto, as long as such materials have the required adhesive properties.

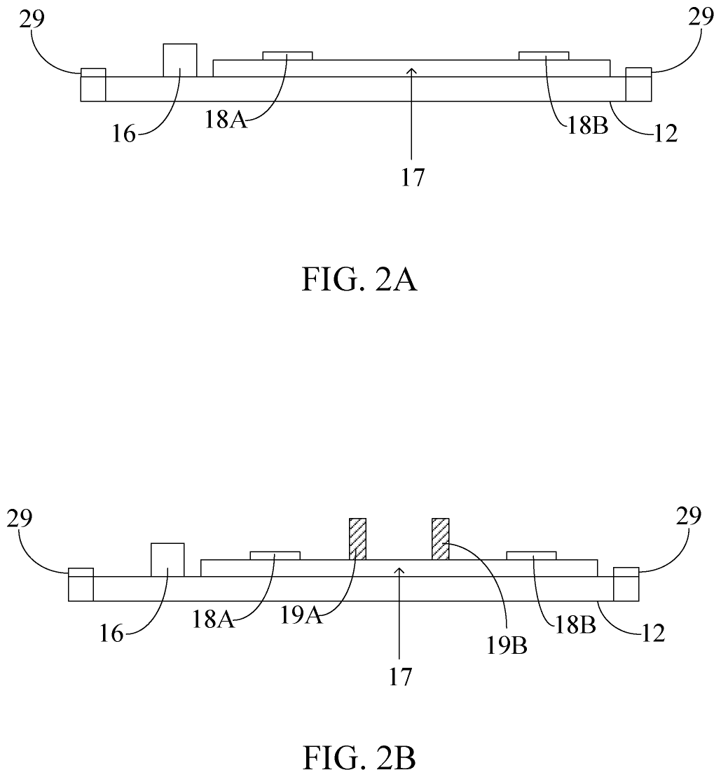

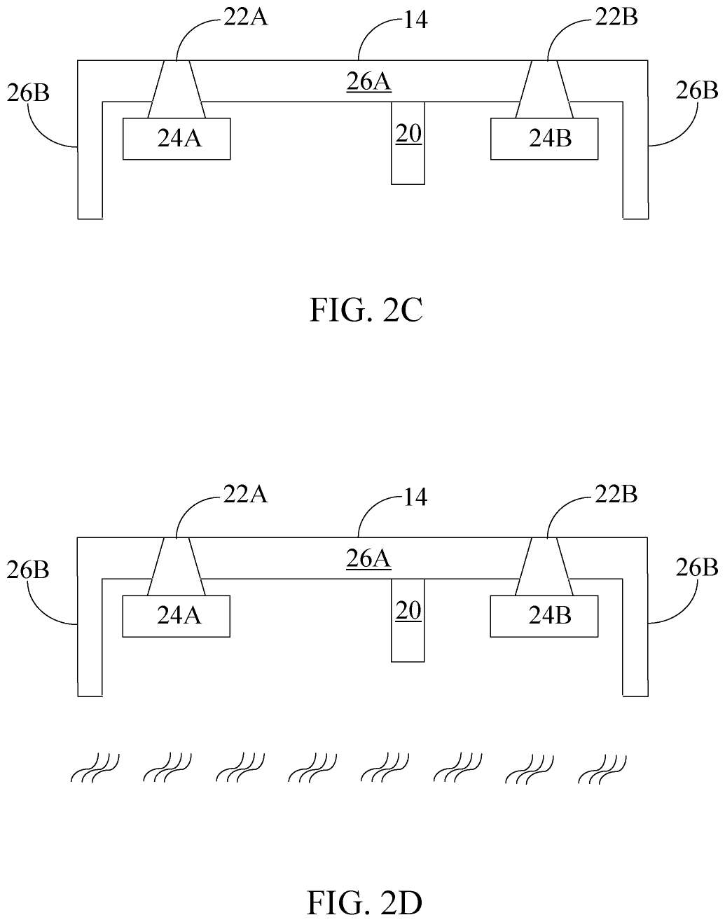

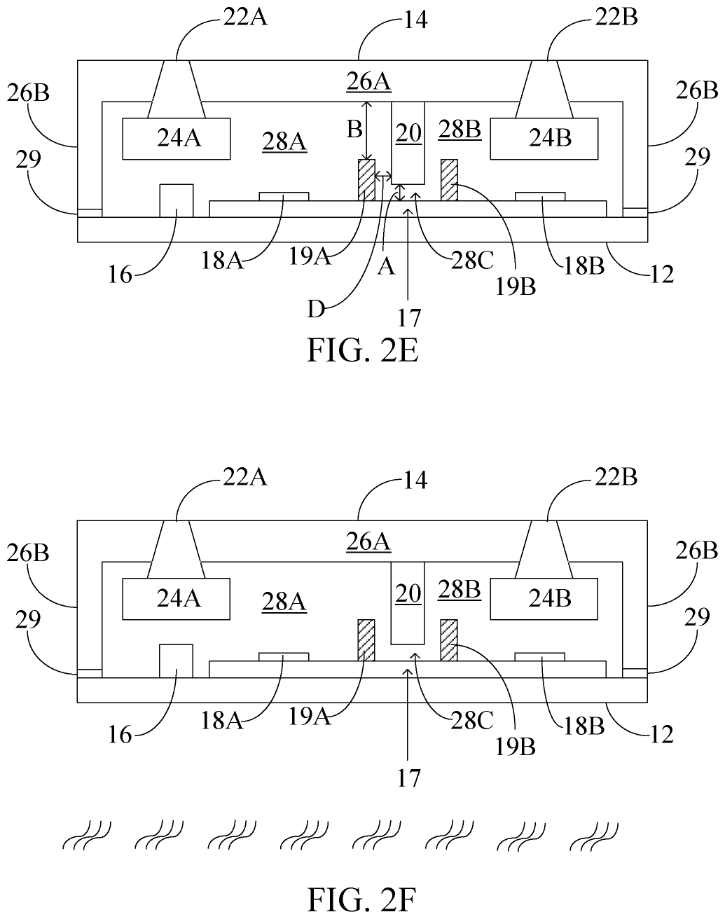

FIGS. 2A-2F illustrate other embodiments for implementation of the method of the disclosure. First, referring to FIG. 2A, the light emitter 16 and the photodetector 17 are disposed on the substrate 12.

According to an embodiment of the disclosure, components can be attached to the substrate 12 through an adhesive layer, and electrical connections made by wire bonding (Wire Bonding), Tape Automated Bonding (TAB), Flip Chip (FC), etc. The substrate 12 can be made of different materials, such as plastic materials, epoxy materials, composite materials, FR-4 materials or ceramic materials. The substrate 12 has an interconnection structure, and has bonding pads to couple with related electronic components. The related electronic components may include circuit components and control circuits necessary for implementing the function of transmitting or receiving light as signals. The related electronic components are well known to those skilled in the art, and will not be repeated here.

In an embodiment of the disclosure, the light emitter 16 can be one or multiple vertical cavity surface emitting laser diodes (hereinafter referred to as VCSELs). The VCSELs form an array to emit light as signals. In other embodiments, the light emitter 16 can be surface-emitting laser diodes, light emitting diodes, edge emitting laser diodes (EELD), or distributed feedback lasers (DFB). In an embodiment of the disclosure, the light emitter 16 is used to emit light beams in the infrared waveband. In other embodiments, the light emitter 16 can also emit light in other wavebands such as visible light and ultraviolet light.

According to an embodiment of the disclosure, the photodetector 17 may include spatially distributed photosensitive elements, such as a reference photodetection component 18A and a measurement photodetection component 18B. Both the reference photodetection component 18A and the measurement photodetection component 18B can sense the light beam emitted by the transmitter 106, but the measured time points are different. The types of measurement photodetection component 18B and reference photodetection component 18A may include PN-type photodiodes, PIN-type photodiodes, avalanche-type photodiodes, charge coupled devices (CCD) and complementary metal-oxide semiconductors (CMOS).

Next, referring to FIG. 2B, a first optical blocking element 19A and a second optical blocking element 19B are provided on the photodetector 17 between the reference photodetection component 18A and the measurement photodetection component 18B. According to an embodiment of the disclosure, the material of the first optical blocking element 19A and the second optical blocking element 19B is a material with light-absorbing properties, such as dark-colored polymer materials coated with black paint or green paint, or the same material as the adhesive layer.

Next, referring to FIG. 2C, a first optical filter 24A and a second optical filter 24B are provided on the cover 14. According to an embodiment, the material of the cover 14 may be an opaque plastic polymer material. The cover 14 comprises a top cover 26A and side walls 26B extending from the periphery of the top cover 26A toward the substrate 12. The cover 14 further comprises a protrusion 20, a first light transmitting portion 22A, and a second light transmitting portion 22B. The protrusion 20 is located on the surface of the top cover 26A facing the substrate 12 and extends toward the substrate 12. According to an embodiment, the protrusion 20 may be an independent element or can be integrally formed with the top cover 26A. The first light filter 24A and the second light filter 24B are respectively fixed in the first light transmitting portion 22A and the second light transmitting portion 22B by adhesive.

Next, referring to FIG. 2D, the cover 14 with the first light filter 24A and the second light filter 24B are baked or cured to solidify the adhesive layer between the light filters and the cover 14. According to the embodiment of the disclosure, the baking temperature can be controlled between 100° C. and 170° C. according to the materials of the first light filter 24A, the second light filter 24B, the cover 14 and the adhesive layer.

Next, referring to FIG. 2E, the cover 14 is connected to the substrate 12 and forms an internal space with the substrate 12. The internal space is divided by the protrusion 20 into a first chamber 28A and a second chamber 28B that communicate with each other. As shown in FIG. 2E, there is a communication chamber 28C between the first chamber 28A and the second chamber 28B, that is, between the bottom of the protrusion 20 and the substrate 12. After the cover 14 and the substrate 12 are combined, the first optical blocking element 19A and the second optical blocking element 19B extends beyond the bottom of the protrusion 20. According to an embodiment of the disclosure, the first optical blocking element 19A and the second optical blocking element 19B reduce the amount of stray and undesired light entering the second chamber 28B from the first chamber 28A through the communication chamber 28C.

As shown in FIG. 2E, there is a first distance A between the bottom of the protrusion 20 and the photodetector 17, a second distance B between the top of the first optical blocking element 19A and the top cover 26A, and a third distance D between the first optical blocking element 19A and the protrusion 20 along the direction parallel to the surface of the substrate 12. The first distance A, the second distance B, and the third distance D are non-zero physical distances.

In addition, according to an embodiment of the disclosure, the substrate 12 and the cover 14 of the optical sensor 10 can be joined adhesively by an adhesive layer 29. According to an embodiment of the disclosure, the adhesive layer 29 can be formed from various materials, including a polyimide (PI), polyethylene terephthalate (PET), Teflon, liquid crystal polymer (LCP), polyethylene (PE), polypropylene (PP), polystyrene (PS), polyvinyl Chloride (PVC), nylon or polyamides, polymethyl polymethylmethacrylate (PMMA), acrylonitrile-butadiene-styrene, phenolic pesins, epoxy resin, polyester, silicone, polyurethane (PU), polyamide-imide (PAI) or a combination thereof, not being limited thereto, as long as such materials have the required adhesive properties.

Next, referring to FIG. 2F, the combined cover 14 and the substrate 12 are baked or cured to solidify the adhesive layer between the cover 14 and the substrate 12. According to the embodiment of the disclosure, the baking temperature can be controlled between 100° C. and 170° C. according to the materials of the substrate 12, the cover 14, and the adhesive layer.

According to an embodiment of the disclosure, referring to FIG. 1, when the optical sensor performs distance measurement, the light emitter 16 located in the first chamber 28A emits a light beam according to the control signal issued by the control circuit (not shown in the figures). The reference photodetection component 18A in the first chamber 28A detects the emitted light beam and generates a reference signal, this being at first time t1. The emitted light beam emitted by the light emitter 16 is emitted to the outside of the optical sensor through the first light filter 24A of the first light transmitting portion 22A. After being reflected by a target (not shown in the figures), the reflected light beam is transmitted into the second chamber 28B through the second light filter 24B of the second light-transmitting portion 22B. At this time, the measuring photodetector 17 in the second chamber 28B detects the reflected light beam and generates a measurement signal at second time t2. Next, the reference signal and measurement signal are transmitted to the control circuit. Since the reference signal and the measurement signal are respectively generated at the first time t1 and the second time t2, the control circuit can obtain the flight time of the measurable light beam (t2-t1) according to the reference signal and the measurement signal. The distance d between the optical sensor and the target to be measured can be obtained by calculating 50% of the product of the flight time (t2-t1) and the speed of light C, thus (d=C*(t2-t1)/2).

The distance measurement system using the optical sensors according to the embodiments of the disclosure can be applied to a variety of devices, such as smart phones, portable computers, smart watches, tablet computers, game devices, televisions, personal computers, internal communication systems, home automation systems, automotive security systems, 3D imaging systems, gesture control systems, touch sensors, fingerprint sensors, diagnostic systems, interactive displays, 3D sensing systems, household appliances, robot vacuum cleaners, display devices, iris recognition systems, etc.

According to the embodiments of the disclosure, the emitted light beam emitted by the light emitter 16 in the first chamber 28A is prevented from entering the second chamber 28B through the communication area 28C by the first optical blocking element 19A. In addition, a second optical blocking element 19B can be added to achieve a better effect. In addition, there is no physical contact between the first optical blocking element 19A and the protrusion 20, which eliminates the manufacturing process of connecting the first optical blocking element 19A with the protrusion 20. This not only simplifies the manufacturing process, but also saves the cost of the adhesive layer. Furthermore, glue overflow or the risk of glue overflow when the adhesive layer is squeezed between the first optical blocking element 19A and the protrusion 20 is avoided, and yield and output of the product are improved.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An optical sensor, comprising:
a substrate;
a cover connected with the substrate and forming an internal space with the substrate, wherein the cover comprises a protrusion, a first light transmitting portion, and a second light transmitting portion, the protrusion extends toward the substrate and has a bottom, and the protrusion divides the internal space into a first chamber and a second chamber connected to the first chamber;
a light emitter disposed on the substrate in the first chamber;
a photodetector disposed on the substrate and comprising a measurement photodetection component in the second chamber; and
a first optical blocking element disposed on the photodetector and extending toward the cover and beyond the bottom of the protrusion.

2. The optical sensor of claim 1, wherein the first light transmitting portion is correspondingly positioned relative to the light emitter, and the second light transmitting portion is correspondingly positioned relative to the measurement photodetection component.

3. The optical sensor of claim 1, wherein the cover further comprises a top cover and side walls extending from a periphery of the top cover toward the substrate, and the side walls are connected to the substrate.

4. The optical sensor of claim 3, wherein the first optical blocking element is disposed in the first chamber and comprises a top portion, a second distance between the top portion and the top cover is defined according to a first preset value, and a third distance between the first optical blocking element and the protrusion is defined according to a second preset value.

5. The optical sensor of claim 1, wherein the light emitter emits a detection light beam according to a control signal, the first light transmitting part is positioned to transmit the detection light beam towards a target to be measured, then a reflected light beam is reflected by the target, and the second light transmitting part is positioned to transmit the reflected light beam to the measurement photodetection component.

6. The optical sensor of claim 5, wherein the photodetector further comprises a reference photodetection component in the first chamber.

7. The optical sensor of claim 6, wherein the protrusion is located between the measurement photodetection component and the reference photodetection component, and a first distance between the bottom of the protrusion and the photodetector is defined according to a third preset value.

8. The optical sensor of claim 7, further comprising a control circuit configured for providing the control signal, wherein the reference photodetection component generates a reference signal according to the detection light beam, the measurement photodetection component generates a measurement signal according to the detection light beam, and the control circuit obtains a flight time according to the reference signal and the measurement signal.

9. The optical sensor of claim 1, further comprising a second optical blocking element disposed on the photodetector in the second chamber between the protrusion and the measurement photodetection component, and extending toward the cover and beyond the bottom of the protrusion.

10. The optical sensor of claim 1, further comprising a first light filter and a second light filter respectively disposed on the first light transmitting portion and the second light transmitting portion.

11. A method for manufacturing an optical sensor, comprising:
providing a substrate;
providing a cover comprising a protrusion, a first light transmitting portion, and a second light transmitting portion;
disposing a light emitter and a photodetector on the substrate, wherein the photodetector comprises a measurement photodetection component;
disposing a first optical blocking element on the photodetector; and
connecting the substrate with the cover and forming an internal space by the substrate and the cover, wherein the protrusion extends toward the substrate and has a bottom and divides the internal space into a first chamber and a second chamber connected to the first chamber, the light emitter and the first optical blocking element are disposed in the first chamber, the measurement photodetection component is disposed in the second chamber, the first optical blocking element is disposed between the light emitter and the protrusion, and the first optical blocking element extends toward the cover and beyond the bottom of the protrusion.

12. The method of claim 11, wherein the first light transmitting portion is correspondingly positioned relative to the light emitter, and the second light transmitting portion is correspondingly positioned relative to the measurement photodetection component.

13. The method of claim 11, further comprising arranging a first distance between the bottom of the protrusion and the photodetector according to a first preset value.

14. The method of claim 11, wherein the cover comprises a top cover and side walls extending from the periphery of the top cover toward the substrate, the side walls are connected to the substrate, and the first optical blocking element has a top portion.

15. The method of claim 14, further comprising arranging a second distance between the top portion and the top cover according to a second preset value, and arranging a third distance between the first optical blocking element and the protrusion according to a third preset value.

16. The method of claim 11, wherein the light emitter emits a detection light beam according to a control signal, the first light transmitting part is positioned to transmit the detection light beam towards a target to be measured, then a reflected light beam is reflected by the target to be measured, and the second light transmitting part is positioned to transmit the reflected light beam to the measurement photodetection component.

17. The method of claim 16, further comprising incorporating a reference photodetection component in the first chamber.

18. The method of claim 17, further comprising adapting a control circuit for providing the control signal, wherein the reference photodetection component generates a reference signal according to the detection light beam, the measurement photodetection component generates a measurement signal according to the detection light beam, and the control circuit obtains a flight time according to the reference signal and the measurement signal.

19. The method of claim 11, further comprising incorporating a first light filter and a second light filter respectively on the first light transmitting portion and the second light transmitting portion.
